(19) United States
(12) Patent Application Publication
(10) Pub. No.: US 2009/0185850 A1
(43) Pub. Date: Jul. 23, 2009

(54) ROTARY-TYPE PEN

(76) Inventor: HUI-I HUNG, Tainan City (TW)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/018,793

(22) Filed: Jan. 23, 2008

(51) Int. Cl. B43K 24/06

(52) U.S. Cl. 401/116

(57) ABSTRACT

A rotary-type pen includes a barrel unit, a refill seat and a rotary drive unit. The barrel unit includes a barrel defining a barrel axis and having an inner barrel surface formed with a helical guiding unit surrounding the barrel axis. The refill seat is guided by the guiding unit to move along the barrel axis for moving a refill relative to the barrel when the refill seat is rotated relative to the barrel. The rotary drive unit includes a rotary knob and a force transmitting member. The rotary knob is retained rotatably on the barrel and is operable to rotate relative to the barrel about the barrel axis. The force transmitting member extends from the rotary knob into the barrel and is coupled co-rotatably to the rotary knob. The force transmitting member drives the rotation of the refill seat in the barrel.

### BACKGROUND OF THE INVENTION

1. Field of the Invention

This invention relates to a pen, more particularly to a rotary-type pen.

2. Description of the Related Art

The field of writing implement design is well established and mature. Familiar types of writing implements include pencils and ballpoint pens. Pens are commonly designed with rotary mechanisms or push button mechanisms for extending a refill to a writing position. Recently, the design of writing implements has seen little innovation that can enhance appeal of the writing implements to consumers.

### SUMMARY OF THE INVENTION

Therefore, the object of the present invention is to provide a rotary-type pen that has a novel configuration to enhance its appeal to consumers.

According to the present invention, there is provided a rotary-type pen adapted for receiving an elongated refill therein. The rotary-type pen comprises a barrel unit, a refill seat and a rotary drive unit.

The barrel unit includes a barrel that is adapted for receiving the refill therein, that defines a barrel axis, and that has an inner barrel surface formed with a helical first guiding unit surrounding the barrel axis.

The refill seat is disposed rotatably in the barrel and is adapted to be coupled to one end of the refill. The refill seat is guided by the first guiding unit to move along the barrel axis for moving the refill relative to the barrel when the refill seat is rotated relative to the barrel.

The rotary drive unit includes a rotary knob and a force transmitting member. The rotary knob is retained rotatably on the barrel and is operable to rotate relative to the barrel about the barrel axis. The force transmitting member extends from the rotary knob into the barrel, and is coupled co-rotatably to the rotary knob. The force transmitting member drives the rotation of the refill seat in the barrel.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a first preferred embodiment of a rotary-type pen according to this invention;

FIG. 2 is a longitudinal sectional view of the first preferred embodiment;

FIG. 3 is a fragmentary enlarged perspective view of the first preferred embodiment;

FIG. 4 is a transverse sectional view to illustrate a refill seat in a barrel of the first preferred embodiment;

FIG. 5 is a transverse sectional view to illustrate a rotary drive unit and a retaining unit of the first preferred embodiment; and

FIG. 6 is an exploded perspective view of a second preferred embodiment of a rotary-type pen according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

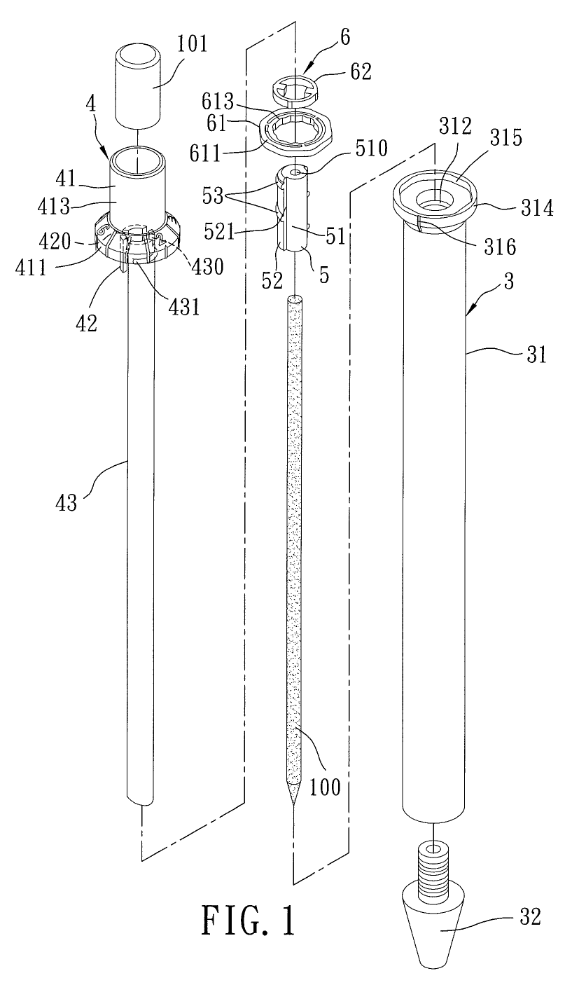

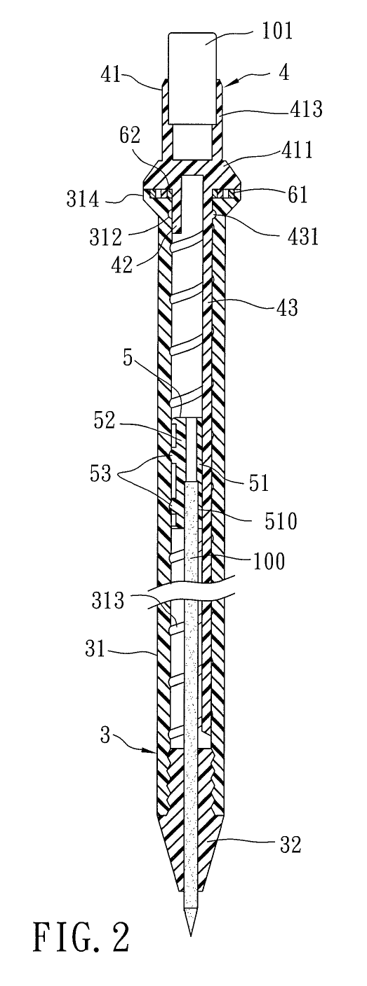

FIGS. 1 and 2 illustrate a first preferred embodiment of a rotary-type pen according to the present invention. The rotary-type pen is adapted for receiving an elongated refill 100 therein and comprises a barrel unit 3, are fill seat 5 and a rotary drive unit 4.

The barrel unit 3 includes a barrel 31 having an inner barrel surface. The barrel 31 is adapted for receiving the refill 100 therein and defines a barrel axis. The inner barrel surface is formed with a helical first guiding unit 313 surrounding the barrel axis. Preferably, the barrel unit 3 further includes a hollow tip cap 32, which is mounted removably to a bottom portion of the barrel 31, and which permits extension of the refill 100 therethrough.

The refill seat 5 is disposed rotatably in the barrel 31, and is adapted to be coupled to one end of the refill 100. The refill seat 5 is guided by the first guiding unit 313 to move along the barrel axis for moving the refill 100 relative to the barrel 31 when the refill seat 5 is rotated relative to the barrel 31.

The rotary drive unit 4 includes a rotary knob 41 and a force transmitting member 43. The rotary knob 41 is retained rotatably on the barrel 31 and is operable to rotate relative to the barrel 31 about the barrel axis. The force transmitting member 43 extends from the rotary knob 41 into the barrel 31 and is coupled co-rotatably to the rotary knob 41. The force transmitting member 43 drives the rotation of the refill seat 5 in the barrel 31. Preferably, the rotary knob 41 is formed with an axial groove adapted for retaining an eraser 101.

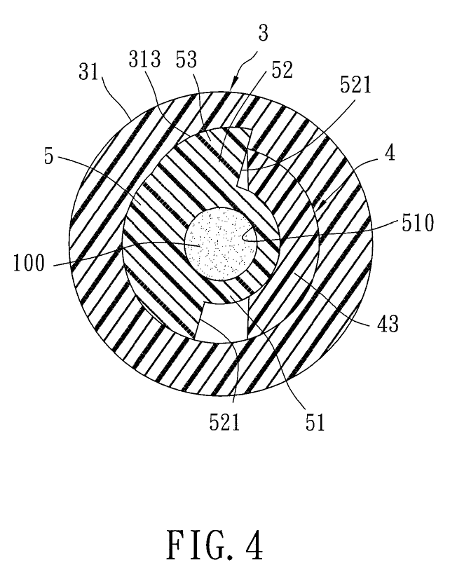

Referring to FIGS. 1, 2, and 4, the refill seat 5 of this embodiment includes a hollow seat body 51, a driven portion 52, and a second guiding unit 53. The hollow seat body 51 is adapted for coupling to the refill 100. Preferably, the seat body 51 is formed with an axial mounting hole 510 for the refill 100 to extend through and be fittingly mounted therein. The driven portion 52 is formed on an outer surface of the seat body 51 and is driven by the force transmitting member 43 to rotate the seat body 51 relative to the barrel 31. Preferably, the driven portion 52 has a pair of driven faces 521, each of which is to be abutted by a respective one of opposite lateral sides of the force transmitting member 43 when the seat body 51 is driven to rotate relative to the barrel 31. The second guiding unit 53 is formed on the outer surface of the seat body 51, i.e., preferably on the driven portion 52, and is slidable along the first guiding unit 313.

In this embodiment, the first guiding unit 313 is a groove formed in the inner barrel surface, and the second guiding unit 53 is a pair of axially spaced apart ribs protruding from the seat body 51 and extending into the groove. Alternatively, the first guiding unit 313 may be a rib protruding from the inner barrel surface, and the second guiding unit 53 may be a groove formed in the seat body 51.

In this embodiment, the inner barrel surface is formed with an annular engaging groove 312, and the force transmitting member 43 is formed with an engaging rib 431 that extends into and that is slidable along the engaging groove 312.

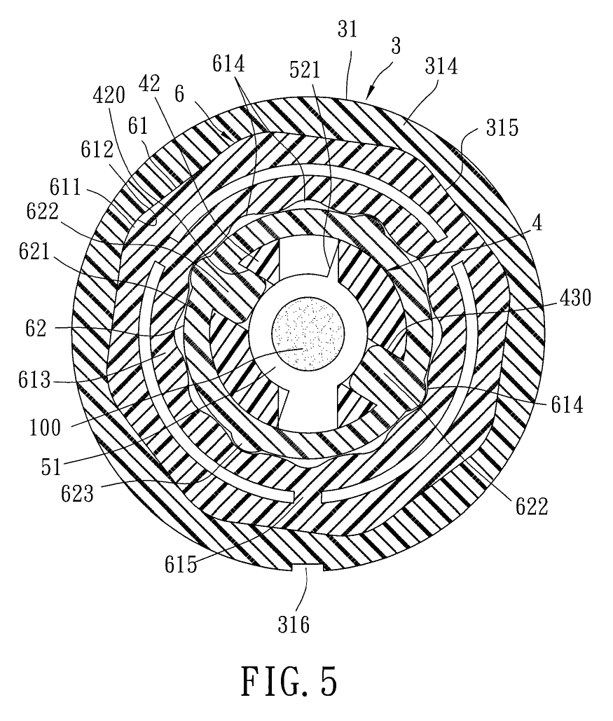

Referring to FIGS. 1, 2, and 5, the rotary-type pen of this embodiment further includes a retaining unit 6 including a first retainer 61 and a second retainer 62. The first retainer 61 is mounted non-rotatably on one end, i.e., the top end, of the barrel 31. The second retainer 62 is coupled co-rotatably to the force transmitting member 43. The second retainer 62 is rotatable relative to the first retainer 61, and is capable of resilient intermittent engagement with the first retainer 61 so as to position the rotary knob 41 at a desired angular orientation relative to the barrel 31.

In this embodiment, the barrel unit 3 further includes a mounting ring 314 mounted on the top end of the barrel 31 and disposed coaxial to the barrel axis. The rotary drive unit 4 further includes a limiting member 42 that extends from the rotary knob 41 into the barrel 31, that is spaced apart from the force transmitting member 43, and that abuts against the inner barrel surface. Preferably, the limiting member 42 and the force transmitting member 43 are formed with a pair of radial holes 420,430 respectively. The first retainer 61 is ring-shaped, is mounted non-rotatably in the mounting ring 314, and has an inner ring surface. The second retainer 62 is ring-shaped, is coupled to the force-transmitting member 43 and the limiting member 42, and is mounted in the mounting ring 314. The second retainer 62 has an outer ring surface that is capable of resilient intermittent engagement with the inner ring surface of the first retainer 61.

Preferably, the mounting ring 314 has a polygonal inner ring wall 315. The first retainer 61 includes an outer ring part 611, an inner ring part 613, and three connecting ribs 615. The outer ring part 611 has a polygonal outer ring surface 612 for engaging non-rotatably the polygonal inner ring wall 315 of the mounting ring 314. The inner ring part 613 is disposed in and is spaced apart from said outer ring part 611. The inner ring part 613 has the inner ring surface of the first retainer 61. The inner ring surface of the first retainer 61 is formed with a plurality of angularly spaced positioning grooves 614. The connecting ribs 615 are spaced apart from each other and interconnect the outer ring part 611 and the inner ring part 613. In this embodiment, the non-rotatable mounting of the first retainer 61 in the mounting ring 314 is achieved through the engagement between the polygonal outer ring surface 612 of the first retainer 61 and the polygonal inner ring wall 315 of the mounting ring 314. However, the manner in which the first retainer 61 is non-rotatably mounted in the mounting ring 314 should not be limited to what is disclosed herein.

In addition, the second retainer 62 includes an engaging ring part 621, a pair of protruding parts 622 and a plurality of positioning parts 623. The engaging ring part 621 is disposed in the inner ring part 613 of the first retainer 61 and is sleeved on the force transmitting member 43 and the limiting member 42. The engaging ring part 621 has the outer ring surface of the second retainer 62. The pair of protruding parts 622 extend from the engaging ring part 621 and engage the radial holes 430, 420 in the force transmitting member 43 and the limiting member 42, respectively. The plurality of positioning parts 623 are angularly spaced and are formed on the outer ring surface of the second retainer 62 for engaging resiliently and removably the positioning grooves 614 of the first retainer 61.

Returning to FIGS. 1 and 2, in this embodiment, the rotary knob 41 is seated on top of the mounting ring 314 so as to secure the first retainer 61 inside the mounting ring 314.

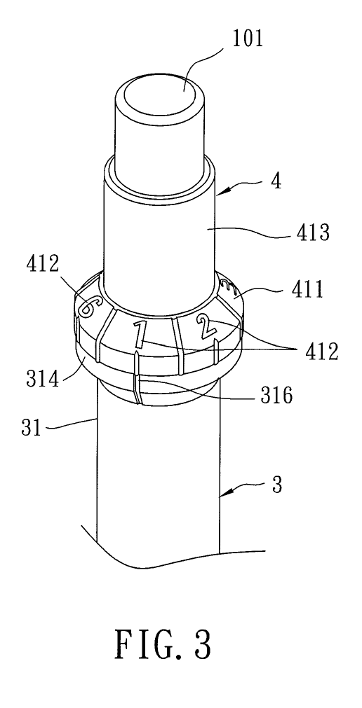

In this embodiment, the mounting ring 314 has an outer ring wall formed with a base marker 316, as shown in FIG. 3. The rotary knob 41 includes a base portion 411 and a drive portion 413. The base portion 411 is seated on top of the mounting ring 314. The drive portion 413 extends from the base portion 411. The base portion 411 has an outer surface provided with a plurality of angularly spaced indicia 412 which can be selectively aligned with the base marker 316. In this embodiment, the indicia 412 are in the form of digits, but in practice, the type and disposition of the indicia are not limited to what is shown in the drawings.

Referring to FIGS. 1, 3, and 5, to use the rotary-type pen, the refill 100 is first inserted upwardly through the barrel 31 and into the refill seat 5. Then, the drive portion 413 of the rotary knob 41 is operated to rotate the force transmitting member 43 relative to the barrel 31, so that one of the lateral sides of the force transmitting member 43 pushes the corresponding one of the driven faces 521 of the driven portion 52 so as to drive the refill seat 5 to rotate relative to the barrel 31. The second guiding portion 53 of the refill seat 5 is thereby moved to slide along the first guiding portion 313 and move the refill seat 5 upwardly or downwardly relative to the barrel 31, thereby driving the refill 100 to move in the same direction relative to the barrel 31. Thus, the refill 100 can be extended through the tip cap 32 to a length suitable for writing.

When the refill 100 is moved relative to the barrel 31, the force transmitting member 43 and the limiting member 42, which are driven by the rotary knob 41, will drive the second retainer 62 to rotate relative to the first retainer 61. When the second retainer 62 rotates, the positioning parts 623 engage the respective corresponding positioning grooves 614. The inner ring part 613 is resiliently deformable so as to enable each positioning part 623 to be shifted to a neighboring one of the positioning grooves 614, thus repositioning the rotary knob 41. Correspondingly, another digit of the indicia 412 will be aligned with the base marker 316, giving the user an indication of the current extended length of the refill 100.

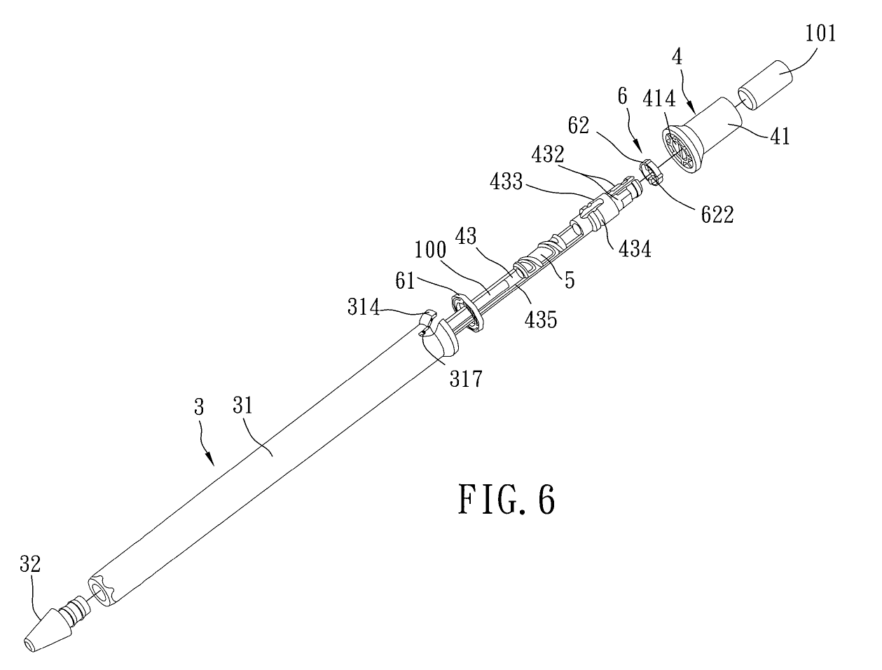

FIG. 6 illustrates a second preferred embodiment of this invention, in which the rotary knob 41 and the force transmitting member 43 of the rotary drive unit 4 are removably engaged. In this embodiment, a top portion of the inner barrel surface is formed with an annular engaging rib 317. The rotary knob 41 has a bottom side formed with an insert groove 414. The force transmitting member 43 has a pair of insert rod portions 432, a connecting rod portion 433, and a force transmitting portion 435. The insert rod portions 432 are inserted removably into the insert groove 414 and have the second retainer 62 of the retaining unit 6 sleeved thereon, and the protruding parts 622 are positioned between the insert rod portions 432. The connecting rod portion 433 extends from the insert rod portions 432 into the barrel 31 and engages rotatably the barrel 31. The force transmitting portion 435 extends from the connecting rod portion 433 and is disposed to abut against the driven portion 52 of the seat body 51 (see FIG. 1) for driving rotation of the refill seat 5 relative to the barrel 31. The connecting rod portion 433 has a periphery formed with an annular engaging groove 434 for rotatable engagement with the annular engaging rib 317. Since the manner of adjusting the length of the refill 100 in the second preferred embodiment is identical to that of the first preferred embodiment, further details of the same are omitted herein for the sake of brevity.

It has thus been shown that, through the operation of the rotary drive unit 4, the refill 100 is moved via the refill seat 5 up and down relative to the barrel 31. Moreover, through the design and function of the first and second retainers 61,62, the rotary knob 41 is rotatably retained on the barrel 31. Furthermore, through the design and function of the base marker 316 and the indicia 412, the extended length of the refill 100 can be accurately indicated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A rotary-type pen adapted for receiving an elongated refill therein, said rotary-type pen comprising:
a barrel unit including a barrel that is adapted for receiving the refill therein, that defines a barrel axis, and that has an inner barrel surface formed with a helical first guiding unit surrounding said barrel axis;
a refill seat disposed rotatably in said barrel, adapted to be coupled to one end of the refill, and guided by said first guiding unit to move along said barrel axis for moving the refill relative to said barrel when said refill seat is rotated relative to said barrel; and
a rotary drive unit including
a rotary knob retained rotatably on said barrel and operable to rotate relative to said barrel about said barrel axis, and
a force transmitting member extending from said rotary knob into said barrel, coupled co-rotatably to said rotary knob, and driving rotation of said refill seat in said barrel.

2. The rotary-type pen as claimed in claim 1, wherein said refill seat includes:
a hollow seat body adapted for coupling to the refill;
a driven portion formed on said seat body and driven by said force transmitting member to rotate said seat body relative to said barrel; and
a second guiding unit formed on said seat body and slidable along said first guiding unit.

3. The rotary-type pen as claimed in claim 2, wherein said first guiding unit is a groove formed in said inner barrel surface, and said second guiding unit is a rib protruding from said seat body and extending into said groove.

4. The rotary-type pen as claimed in claim 1, further comprising a retaining unit including a first retainer mounted non-rotatably on one end of said barrel, and a second retainer coupled co-rotatably to said force transmitting member, rotatable relative to said first retainer, and capable of resilient intermittent engagement with said first retainer so as to position said rotary knob at a desired angular orientation relative to said barrel.

5. The rotary-type pen as claimed in claim 4, wherein:
said barrel unit further includes a mounting ring mounted on said one end of said barrel and disposed coaxial to said barrel axis;
said rotary drive unit further includes a limiting member extending from said rotary knob into said barrel, spaced apart from said force transmitting member, and abutting against said inner barrel surface;
said first retainer is ring-shaped, is mounted non-rotatably in said mounting ring, and has an inner ring surface; and
said second retainer is ring-shaped, is coupled to said force transmitting member and said limiting member, is mounted in said mounting ring, and has an outer ring surface that is capable of resilient intermittent engagement with said inner ring surface of said first retainer.

6. The rotary-type pen as claimed in claim 5, wherein:
said mounting ring has a polygonal inner ring wall;
said first retainer includes
an outer ring part having a polygonal outer ring surface to engage non-rotatably said polygonal inner ring wall of said mounting ring,
an inner ring part disposed in and spaced apart from said outer ring part, said inner ring part having said inner ring surface of said first retainer, said inner ring surface of said first retainer being formed with a plurality of angularly spaced positioning grooves, and
at least two spaced apart connecting ribs interconnecting said outer ring part and said inner ring part; and
said second retainer includes
an engaging ring part disposed in said inner ring part of said first retainer, sleeved on said force transmitting member and said limiting member, and having said outer ring surface of said second retainer,
a pair of protruding parts extending from said engaging ring part and engaging said force transmitting member and said limiting member, respectively, and
a plurality of angularly spaced positioning parts formed on said outer ring surface of said second retainer for engaging resiliently and removably said positioning grooves of said first retainer.

7. The rotary-type pen as claimed in claim 6, wherein said rotary knob is seated on top of said mounting ring so as to secure said first retainer inside said mounting ring.

8. The rotary-type pen as claimed in claim 5, wherein:
said mounting ring has an outer ring wall formed with a base marker; and
said rotary knob includes a base portion seated on top of said mounting ring, and a drive portion extending from said base portion, said base portion having an outer surface provided with a plurality of angularly spaced indicia to be selectively aligned with said base marker.

9. The rotary-type pen as claimed in claim 4, wherein said refill seat includes:
a hollow seat body adapted for coupling to the refill;
a driven portion formed on said seat body and driven by said force transmitting member to rotate said seat body relative to said barrel; and
a second guiding unit formed on said seat body and slidable along said first guiding unit.

10. The rotary-type pen as claimed in claim 9, wherein:
said rotary knob has a bottom side formed with an insert groove; and
said force transmitting member has
a pair of insert rod portions that are inserted removably into said insert groove and that have said second retainer sleeved thereon,
a connecting rod portion which extends from said insert rod portions into said barrel and which engages rotatably said barrel, and
a force transmitting portion which extends from said connecting rod portion and which is disposed to abut against said driven portion of said seat body for driving rotation of said refill seat relative to said barrel.

11. The rotary-type pen as claimed in claim 1, wherein said inner barrel surface is formed with an annular engaging groove, and said force transmitting member is formed with an engaging rib that extends into and that is slidable along said engaging groove.
